(19) United States
(12) Patent Application Publication
(10) Pub. No.: US 2008/0046218 A1
(43) Pub. Date: Feb. 21, 2008

(54) Visual summarization of activity data of a computing session

(75) Inventors: Lubomira A. Dontcheva, Seattle, WA (US); Steven M. Drucker, Bellevue, WA (US); Michael F. Cohen, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/504,834

(22) Filed: Aug. 16, 2006

(51) Int. Cl. G06F 17/00; G06F 17/40

(52) U.S. Cl. 702/186; 702/182; 702/187; 702/189

(57) ABSTRACT

Architecture for tracking, capturing, and visually summarizing information related to user activities and interactions of a network or web computing session. Documents or pages accessed during the session are tracked and presented graphically as miniature images that illustrate a history of the session of documents deemed important by the user. Activities tracked can be related to the dwell time at a web page, scrolling event(s) in the page, click-through activity, impression activity, referencing information of that page to other pages, the information sought, user intentions, goals, etc. The history of session documents are illustrated as a set of reduced images which can be manually and automatically filtered to graphically emphasize one subset of images more than another subset of images based on user criteria.

### BACKGROUND

The Internet has drastically changed the way information is searched and utilized. Users can plan trips, comparison shop, read reviews about products and services, stay up-to-date on the latest news around the world, and a perform a variety of other online tasks all from a computer connected to the Internet. Conventional mechanisms for tracking user activity involve storing cookies on the user's system that provide limited information about the user activity with a website, for example. Another mechanism provides a tabular listing of visited sites, which is also a limited view of what the user has seen.

Given the enormous amount of information on the Internet, as sophisticated users start conducting more network activity (e.g., extensive web-based research), it often takes a significant amount of time and effort to decide on particular courses of action. Additionally, given the diversity of sites that can be visited or information that can be accessed and the fact that the user can be searching over intermittent periods of time, coming back to the last point in time of the session (e.g., research process) is problematic. Moreover, once complete, finding an effective and efficient way of summarizing the session can be impossible. Further, in the context of research sessions, research results are oftentimes required to be shared with other research personnel, leaving conventional systems lacking in the desired capabilities.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The disclosed architecture provides a mechanism for visually summarizing user activities during a computing session as a historical representation of the session activities by tracking and capturing information related to the user activities and interactions during the session. User activities that are tracked can include the dwell time at a web page (or document), scrolling event(s) in the page, click-through activity, impression activity, referencing information of that page to other pages, information being searched and, the intentions and goals of the user, for example. By recording not only the web pages (or documents) visited but the overall activity as well, this information can be employed to determine manually and automatically what is deemed important by the user.

The session activity is composed, arranged, and summarized graphically for visualization by the user and/or shared for visualization by other users. Based on this visualization, the user can quickly deal with large amounts of information through at least an organized clustering of related material, graphical emphasis of important items, and graphical de-emphasis (or even hiding) of less important material.

The disclosed architecture can be employed in combination with other applications or programs to assist in generating a session history. For example, one implementation interfaces to a browser application, thereby assisting the computer in determining what information is deemed relevant and not relevant, visually summarizing user activity related to a web-based (or Internet-based) session, for example, by recording the user activity and web pages accessed, converting accessed documents (or web pages) to thumbnail images, and arranging the images temporally and according to user criteria of importance.

In support thereof, the architecture disclosed and claimed herein comprises a computer-implemented system that facilitates visual summarization of user computing activity. The system comprises a tracking component for tracking user activity data of a computing session, and a visualization component for summarizing the user activity data as a historical visual presentation.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that facilitates summarization of user computing activity.

FIG. 2 illustrates a computer-implemented methodology of summarizing user computing activity.

FIG. 3 illustrates an alternative system that facilitates generation and presentation of a visual summary of a computing session.

FIG. 4 illustrates an alternative system that employs a decision-theoretic component which facilitates automating one or more features.

FIG. 5 illustrates a methodology of arranging session summarization information according to priority or importance to the user.

FIG. 6 illustrates a methodology of manually adjusting visual presentation of activity data representations.

FIG. 7 illustrates a methodology of providing an area for user annotation of the activity data.

FIG. 8 illustrates a methodology of tracking activity data during the computing session.

FIG. 9 illustrates a methodology of providing a dynamic interface for navigating a visual summarization presentation.

FIG. 10 illustrates a methodology of employing a decision-theoretic algorithm that facilitates organizing summary representations historically.

FIG. 11 illustrates a methodology of accessing and sharing a session file.

FIG. 12 illustrates reduction of an annotated web document associated with user activity.

FIG. 13 illustrates a more extensive diagram of a summary interface for visual summarization in accordance with the subject architecture.

FIG. 14 illustrates a block diagram of a computer operable to execute the disclosed visual summarization and presentation architecture.

FIG. 15 illustrates a schematic block diagram of an exemplary computing environment that facilitates visual summarization and presentation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The disclosed architecture records all or a substantial portion of activity associated with a computing session (e.g., a web session) including but not limited to page dwell time, paths (or links) to pages in order to help better visualize the results, browser usage, window changes, and even telephone usage. Tracking (or recording) can be via a logger that logs how users actually use program interfaces. Additionally, a mechanism is provided for visually summarizing user activities during the computing session as a historical representation of the activities by tracking and capturing information related to the user activities and interactions during the session. Visualization and summarization techniques include providing the capability to view large collections of web pages or documents, cluster the documents according to clustering criteria, emphasize important material, eliminate or de-emphasize less relevant material, and eliding supporting material.

In one implementation of a web session context, all web pages that the user specified as important can be shown at the top of the user interface summarization window (e.g., as thumbnail images and a summarized version). The visual summary facilitates rapid navigation to any point in the entire session history. The session history can include clustering of information based on, for example, when the user enters textual information (e.g., into a search page and/or into the web-URL itself). Other ways of clustering information can be based on when the user selects a URL from another program (e.g., an e-mail or instant message). Slider controls can be employed to allow a user to filter information presented up to eliminating information entirely that is less important. Additionally, the user can expand the pages that lead up in time to a certain page. The view can also include web dwell time as criteria for filtering what pages (or image) are to be shown.

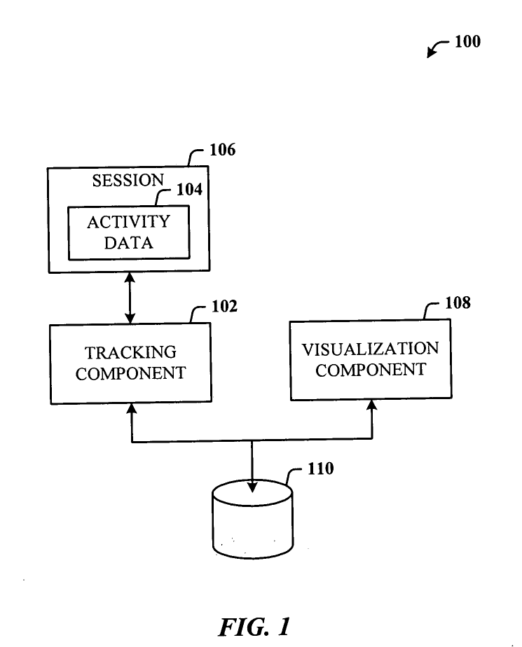

Referring initially to the drawings, FIG. 1 illustrates a computer-implemented system 100 that facilitates the summarization of user computing activity. The system 100 includes a tracking component 102 for tracking activity data 104 of (e.g., user activity, application activity, . . . ) a computing session 106, and a visualization component 108 for summarizing the activity data 104 as a historical visual presentation. The activity data 104 and visual presentation data can be stored on a datastore 110 as a session file associated with the session 106 and for later retrieval.

The tracking component 102 facilitates storage of the session file of the session for sharing with and visualization by another user or users. For example, the session file can be placed in a shared workspace for access by multiple users, granted access to its current location by one or more other users or systems and/or transmitted for to other users or systems for access and presentation.

The system 100 can be employed in combination with other applications or programs to assist in generating a session history. For example, one implementation interfaces the system 100 to a browser application, thereby assisting the computer in determining what information should be deemed relevant and not relevant, visually summarizing user activity related to a web-based (or Internet-based) session, for example, by recording the user activity and web pages accessed, converting accessed documents (or web pages) to thumbnail images (or other miniature graphical representations, e.g., text-based summaries or annotations), and arranging the images temporally and according to user criteria of importance.

In alternative implementation, the system 100 is employed in an enterprise setting and provides a historical visualization of documents of an intranet session by recording user activity of the enterprise network, reducing the accessed network documents to thumbnail images (or text), clustering the images according to user criteria (e.g., information input by the user, tagged by the user, . . . ), and graphically emphasizing one subset of the images more than another subset of images by filtering the history of thumbnail images based on what the user desires to perceive.

In yet another alternative implementation, the architecture provides a visualization of documents of an offline session by recording user activity local to the user computer through a local application, reducing the accessed data and/or documents to thumbnail images (and/or text), clustering the images according to user criteria (e.g., information input by the user, tagged by the user, . . . ), and graphically emphasizing one subset of the images more than another subset of images by filtering the history of thumbnail images based on what the user desires to perceive.

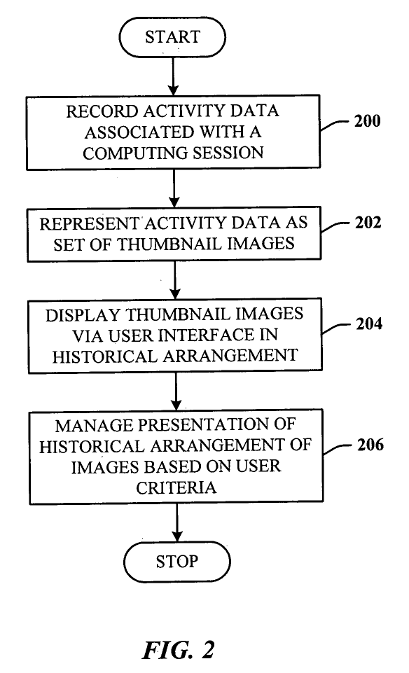

FIG. 2 illustrates a computer-implemented methodology of summarizing user computing activity. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, activity data associated with an online computing session is recorded. At 204, the activity data is represented as a set of thumbnail images (although the data can be represented as text snippets). At 204, the thumbnail images are displayed via a user interface in an arrangement (e.g., chronological) that provides a historical perspective of the activity data. At 206, presentation of the historical arrangement of thumbnail images is managed based on user criteria. For example, the user criteria can include user preferences as to how the visual summarization should be presented using thumbnail images, text summaries or annotations, or a combination of both. Other criteria can be based on system capabilities. For example, if the system is deployed in a small portable wireless device where display real estate is more limited than on a larger desktop computing system or portable computer, visual presentation is managed for suitable presentation and summarization of the session.

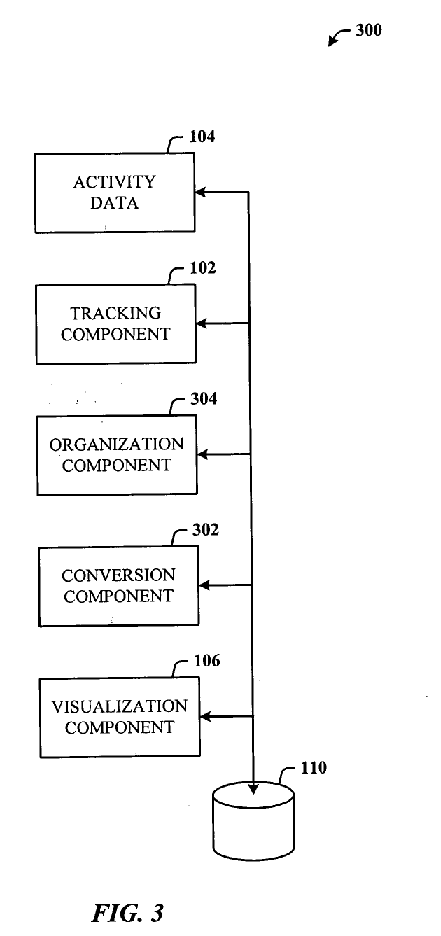

Referring now to FIG. 3, there is illustrated an alternative system 300 that facilitates generation and presentation of a visual summary of a computing session. In addition to including the tracking component 102 for tracking the activity data 104, the visualization component 106 for presenting a visual representation of the session activities and data, and the datastore 110 for storing the session information, the system 300 can further include a conversion component 302 for converting the activity data 104 and document data into a graphical representations (e.g., a thumbnail image) for presentation, and an organization component 304 for organizing the graphical representations according to a desired arrangement.

The conversion component 302 not only facilitates conversion of the activity data 104 into a miniature graphical representation, but can also facilitate conversion and association of the activity data with textual information that can be displayed, rather than the images. In one implementation, the user can interact with the user interface to cause toggling between the images and the textual information. In another implementation, and in accordance with user preferences, the activity data will always be represented as images, until such time as the user chooses to see the visual summarization as textual information (or snippets) or a combination of textual and image data.

The conversion component 302 facilitates presenting a border area (e.g., an annotation area) with a document (e.g., a web page) such that textual information can be inserted manually into the area, or document content selected for annotation in the area, for example. Thus, the annotated data can be converted with the document into the thumbnail image.

The organization component 304 facilitates arranging the graphically represented session information into one or more different arrangements or orientations. For example, the session information can be summarized in a left-to-right presentation to give the user an intuitive feeling that the chronology of the session has progressed from left to right. However, it is within contemplation of the subject innovation that the orientation can be configured to be presented chronologically in a top-down orientation, or any other orientation that the user desires.

The organization component 304 also facilitates prioritizing or ranking the session information (e.g., thumbnail images and/or textual content) according to criteria. For example, the user may desire that all first web page documents of new websites be displayed near the top of the display, while subsequent website documents are displayed as thumbnail images near the bottom of the display. In another example, all impressions resulting from a click-through of a first document are displayed as thumbnail images in a stacked offset orientation below the thumbnail image of the first document. These are only a few of the examples in which organization can be configured for the disclosed architecture.

The visualization component 106 also facilitates controlling visualization effects of the user interface. For example, user selectors (e.g., sliders or radio buttons) can be provided on the interface that allow the user to manually control graphical effects. In one example, filtering is performed using a filtering slider control where as the user moves the slider, thumbnail images of lesser relevance are caused to fade out of view leaving only the more relevant (or important) images in view. In another example, visual effects are provided that allow the user to zoom in on selected ones of the images for easier viewing of the image content and/or annotations.

In still another example, visual or interface control capabilities provided allow the user to scroll left or right (up or down) along one set of images while other images in the interface remain stationary in the interface. Other selectors or controls can be provided that allow toggling between images and textual content, for example. Many other types of visual effects can be configured for utilization by the user interface for robust visual effects and for navigating the summary data. For example, select ones of a string of the images can be viewed in a zoom mode while adjacent images remain in a reduced mode. In yet another example, selection of an important (or relevant) image automatically causes clustered viewing of related activity data or images in an expanded or zoom mode.

The visualization component 106 also facilitates graphically emphasizing relevant or important images by changing (e.g., highlighting) the associated graphics. De-emphasis of less relevant or unimportant images or text can be provided by changing the image graphic to a different color (e.g., graying out) that indicates to the user the less important status of the graphic, and hence, the activity data.

The tracking component 102 can track a wide variety of activity data, including, but not limited to, dwell time that the user spends viewing to interacting with a document (or web page), scrolling events while interfacing with the document, click-through, what other documents are referenced by the document, the information searched, input text, document content, tagging events by the user as a means for visual effects and organization, and so on.

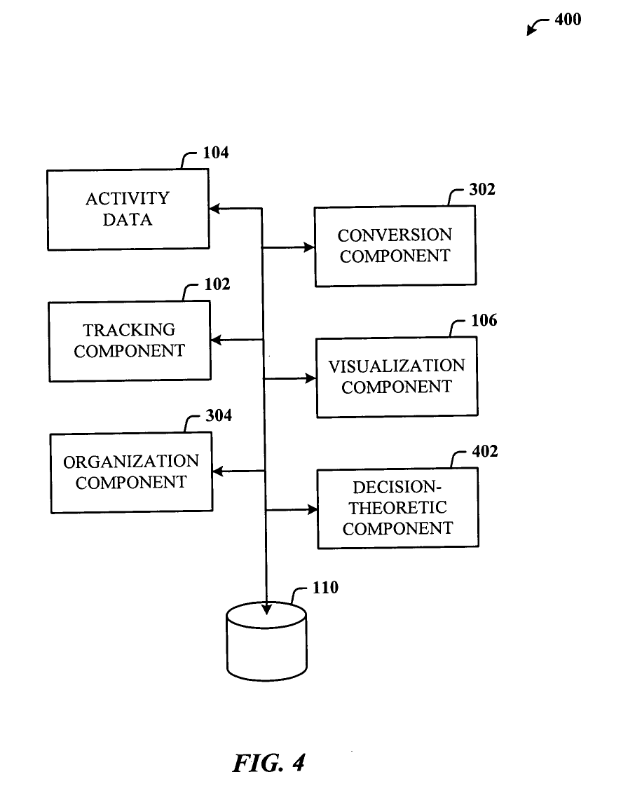

FIG. 4 illustrates an alternative system 400 that employs a decision-theoretic component 402 which facilitates automating one or more features. The component 402 can include machine learning and reasoning (MLR) to learn and reason about user activities, activity data, and system activities related to at least the computing session.

The subject architecture (e.g., in connection with selection) can employ various MLR-based schemes for carrying out various aspects thereof. For example, a process for determining how to cluster and organize information for visual summarization can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or other statistical analysis (e.g., one factoring into the analysis utilities and costs to maximize the expected value to one or more people) to prognose or infer an action that a user desires to be automatically performed.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, for example, various forms of statistical regression, naïve Bayes, Bayesian networks, decision trees, neural networks, fuzzy logic models, and other statistical classification models representing different patterns of independence can be employed. Classification as used herein also is inclusive of methods used to assign rank and/or priority.

As will be readily appreciated from the subject specification, the subject architecture can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions according to predetermined criteria.

In one example, the component 402 facilitates learning and reasoning about user habits and/or preferences during the computing session such as preferring that visual presentation aligns priority images along the top of the interface and less relevant images along the bottom of the interface. Thus, as the user repeatedly configures or interacts with the system to perform this layout, the component 402 will learn and reason about this to automatically default to this orientation and/or arrangement for future sessions. Other examples can include automatic selection of the relevant data versus the less relevant data, determining if the activity data should be reduced to text or images, or both, determining what user activity to track and not track, and so on.

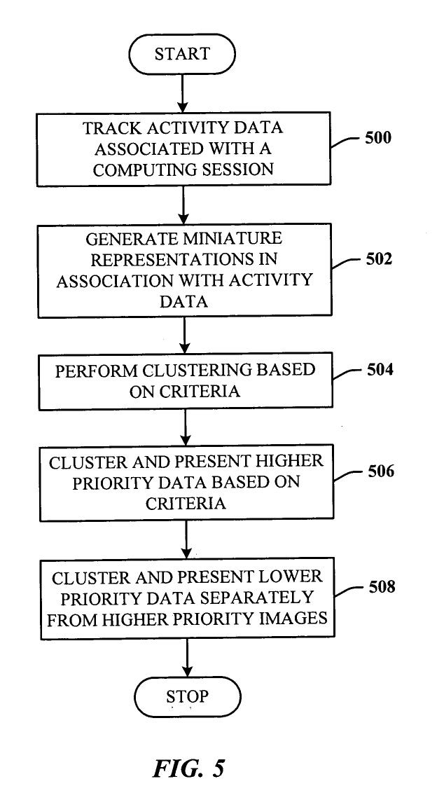

FIG. 5 illustrates a methodology of arranging session summarization information according to priority or importance to the user. At 500, activity data associated with a computing session is tracked. At 502, miniature representations (e.g., thumbnail images, text summaries) of the activity data are generated. At 504, clustering of the data is performed based on criteria. For example, the criteria can be user preferences information, based on system limitations in presentation and computing power, time of day, user input search terms, user-tagged content, user annotated content, machine learning and reasoning analysis, and so on. At 506, higher priority data is clustered and presented at one location based on the criteria. At 508, lower priority data is clustered and presented at a location separate or different than the high-priority data location.

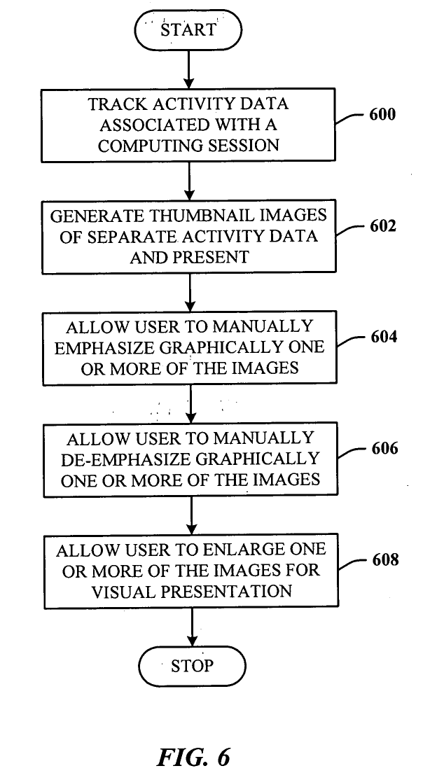

FIG. 6 illustrates a methodology of manually adjusting visual presentation of activity data representations. At 600, activity data of a computing session is tracked. At 602, thumbnail images of separate activity data is generated and presented. At 604, the user is allowed to manually emphasize graphically one or more of the images. User control can be by causing the interface to provide graphical coloring or highlighting for what the user considers to be associated with more important, higher priority or more relevant data. Note that this can be performed automatically by the system where the user tags or the system infers that certain activity data is desired to be emphasized differently than other visual summarization images.

Accordingly, at 606, the user is allowed to manually de-emphasize graphically one or more of the images. Again, user control can be by causing the interface to provide graphical coloring or highlighting for what the user considers to be associated with less important, lower priority or less relevant data. This also can be performed automatically by the system where the user tags or the system infers that certain activity data is desired to be emphasized differently than other visual summarization images.

At 608, the user is allowed to navigate and view one or more of the images of the visual presentation. For example, the user can select an image for zoom mode to enlarge the image for better viewing. In one implementation, the selected image can be from a cluster of images deemed more important than another cluster of images. In response, not only is the selected image enlarged, but also associated images in the less important cluster proximate in time to the selected image. Thus, the user can configure the system to grab activity data in a window of time about the selected image to provide some intuitive sense of context of what the user was doing before and after the selected activity.

Note that although this description focuses generally on thumbnail images as representations of the activity data, it is to be understood that whenever thumbnail images are described, alternatively, the representations can be short textual summaries or snippets of textual content or annotation, or combinations of thumbnail images and textual content.

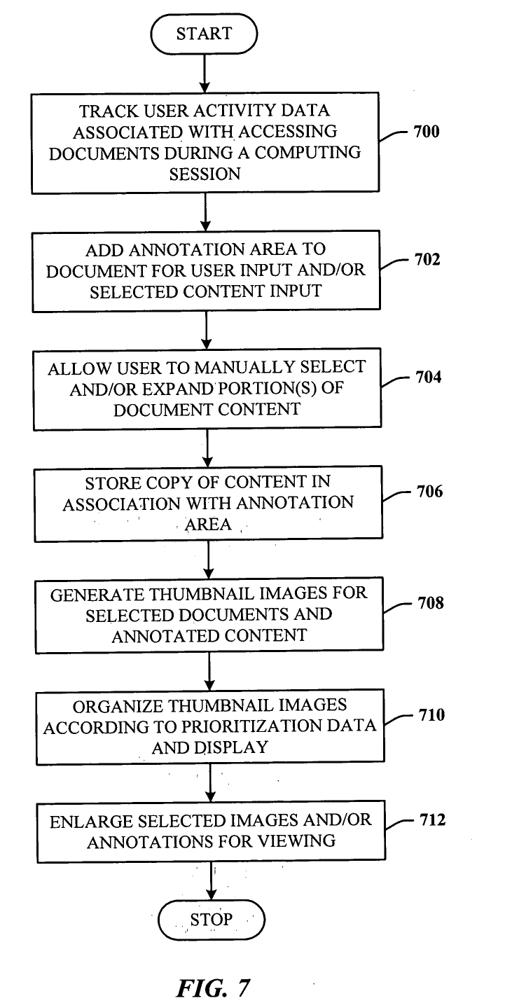

FIG. 7 illustrates a methodology of providing an area for user annotation of the activity data. At 700, user activity data associated with accessing documents (e.g., web pages) during a computing session is tracked. At 702, the document is captured and an area for annotation is associated with the document for user input and/or input of selected content. At 704, the user selects and/or causes to be selected an enlarged portion(s) of the document content. At 706, a copy of the selected content is stored in association with the annotation area. At 708, a thumbnail image is created for selected documents, annotation area, and annotated content. At 710, the images are organized according to prioritization criteria and displayed. At 712, selected images and/or annotations can be enlarged for suitable viewing.

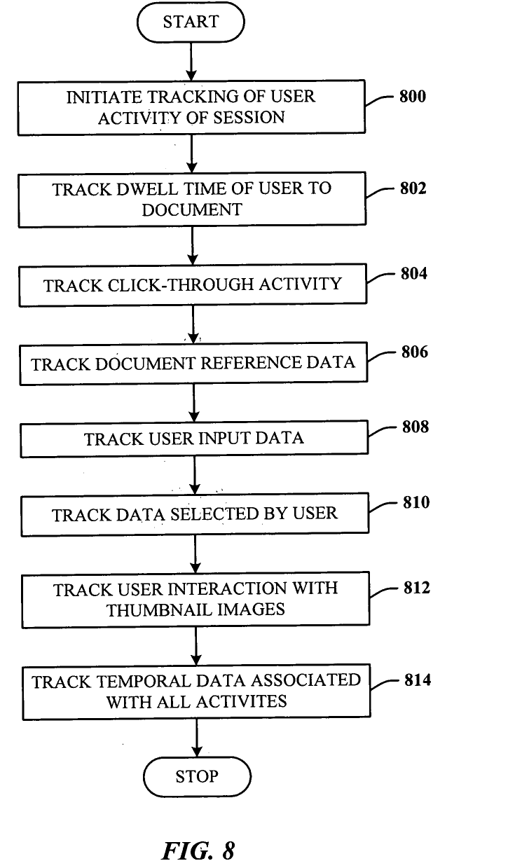

FIG. 8 illustrates a methodology of tracking activity data during the computing session. At 800, activity tracking is initiated. At 802, dwell time of the user and a document can be computed. At 804, click-through activity of a document can be tracked. At 806, document references to other documents can be tracked and recorded. At 808, user input data can be tracked. At 810, data selected by the user can be tracked. For example, if the user highlights or copies a portion of the document content (e.g., text, images, links), this can be tracked. At 812, during the visual summarization phase, user interaction of the representations such as the thumbnail images can be tracked as a means of inferring intentions and goals, for example. At 814, all user activity can be time stamped such that chronological information can be maintained and a historical summarization presented.

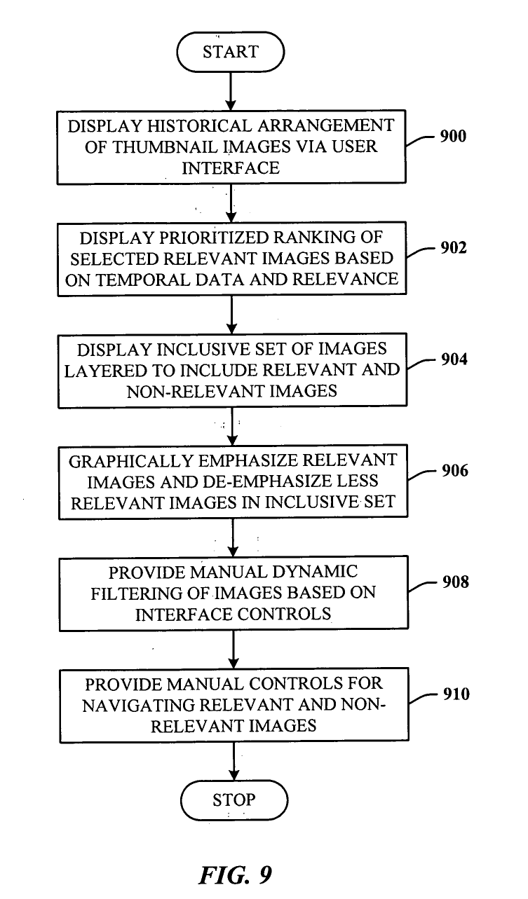

FIG. 9 illustrates a methodology of providing a dynamic interface for navigating a visual summarization presentation. At 900, a historical arrangement of images is displayed via a user interface. This interface can be provided as part of a browser, for example, such that user activities during the browsing session are tracked, as well as web pages visited and accessed, and impressions downloaded. In another implementation, the interface is a plug-in to the browser, or an add-in to another application (e.g., a development tool) such that tracking, organization and visual summarization is facilitated.

At 902, a prioritized ranking of selected relevant images is displayed based on temporal data and relevance to user interests at the time of the session. For example, the set of prioritized and temporally ordered images can be displayed along the top of the user interface window. At 904, an all-inclusive set of images is displayed is a different setting using an offset layered effect to indicate not only the relevant documents, but the less relevant documents and associated activity. The layered effect facilitates using less window real estate yet indicating to the user that additional documents are available in the visual summary.

At 906, relevant images of the all-inclusive set can be graphically emphasized while less relevant images are de-emphasized by other graphical means. Thus, the user can readily visually perceive activity data in at least two settings: a dataset considered to be of a particularly high relevance to the user's interests, and an all-inclusive dataset showing graphical representations of different levels of relevancy to the user's interests. At 908, the user interface provides dynamic filtering of the all-inclusive set (e.g., of images), wherein the user can manually adjust a filtering slider to fade out less relevant images before fading out the more relevant images.

Note that many different types of filtering controls can be provided for manually filtering the summary. For example, after selecting a relevant or higher priority image, another control can be provided that when activated, dynamically clusters and enlarges all related images within a certain time period or window about the time of the selected image. At 910, manual user-selectable controls can be provided for navigating relevant and non-relevant images. For example, grabbing and moving images can be provided. Another example includes bounding a set of images in a box, in response to which all images within the box are enlarged for viewing. These are only a few of the many types of control that can be provided to allow the user to more easily and intuitively navigate and examine the session summary.

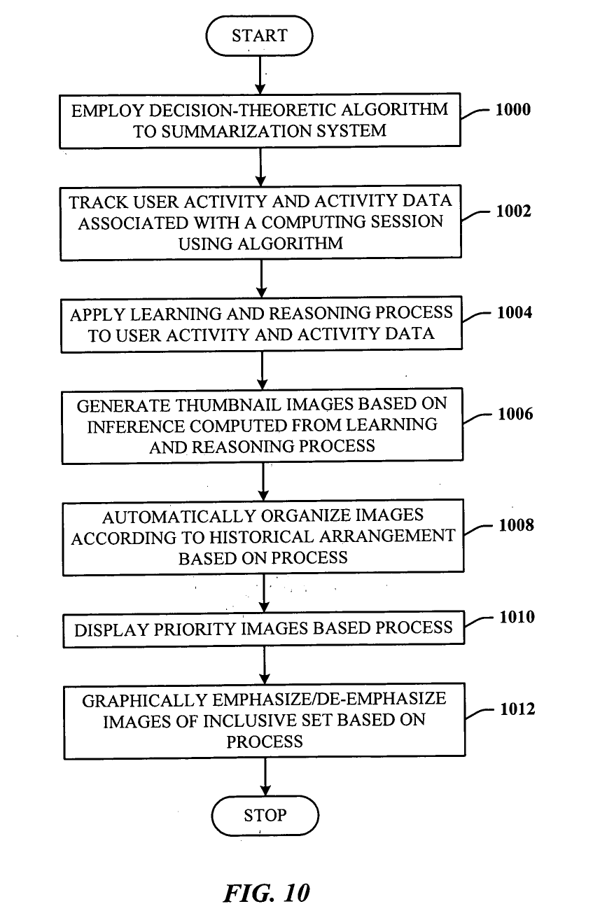

FIG. 10 illustrates a methodology of employing a decision-theoretic algorithm to facilitate organizing summary representations historically. At 1000, a decision-theoretic algorithm is employed with the summarization system. At 1002, user activity is tracked and activity data associated with a computing session. The algorithm monitors this user activity and activity data. At 1004, a learning and reasoning process is applied to the user activity and activity data. At 1006, thumbnail images are generated based on inferences computed from the learning and reasoning process. At 1008, images are automatically organized according to a historical arrangement based on the process. At 1010, priority images are selected and displayed based on the process. At 1012, images are graphically emphasized and/or de-emphasized based on the process.

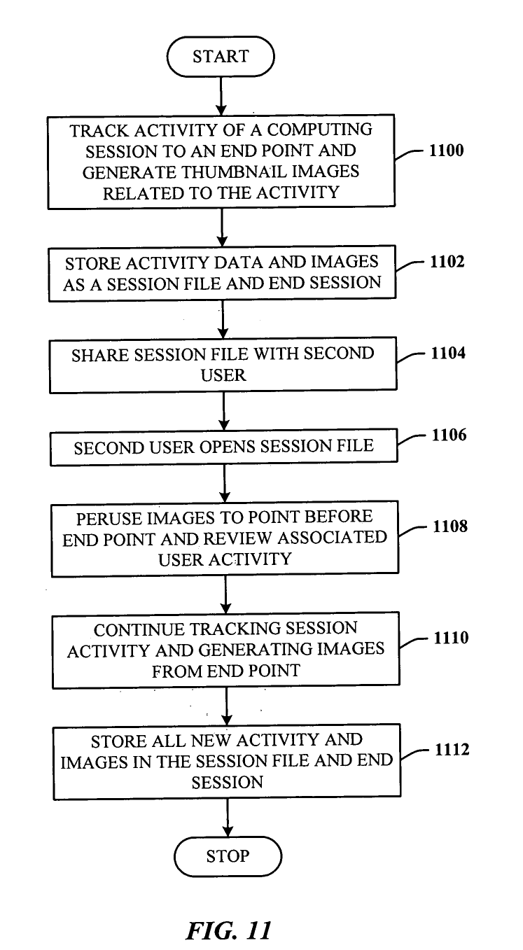

FIG. 11 illustrates a methodology of accessing and sharing a session file. At 1100, activity associated with a computing session is tracked to an end point and graphical representations associated with the activity generated. At 1102, activity data and images are stored as a session file and the session is ended. At 1104, the session file can then be transmitted to or shared with a second user for access. At 1106, the second user opens the session file. At 1108, the user can peruse images and/or other representations using means described above for navigating and filtering, for example. In other words, the second user can look back to a point in time before the end point of the first user activity, and access activity data tracked at the point in time.

Additionally, the second user can continue session activity from the end point of the first user. Accordingly, at 1110, the second user initiates a session that appends activity data to the session file beginning from the end point of the first user. At 1112, the system tracks all new activity, generates corresponding representations (e.g., thumbnail images), and displays the summary visualization that includes first user activity as well as second user activity. This can be facilitated by the collaborator having the same or similar applications and/or using a shared file system, for example.

It is to be understood that the above description applies equally to a single user who re-opens a previously-saved first-user computing session file, navigates the activity data via the visual summary, conducts new activity that inserts new activity graphical representations at any point in the existing visual summary, and/or appends new session activity data to the session file.

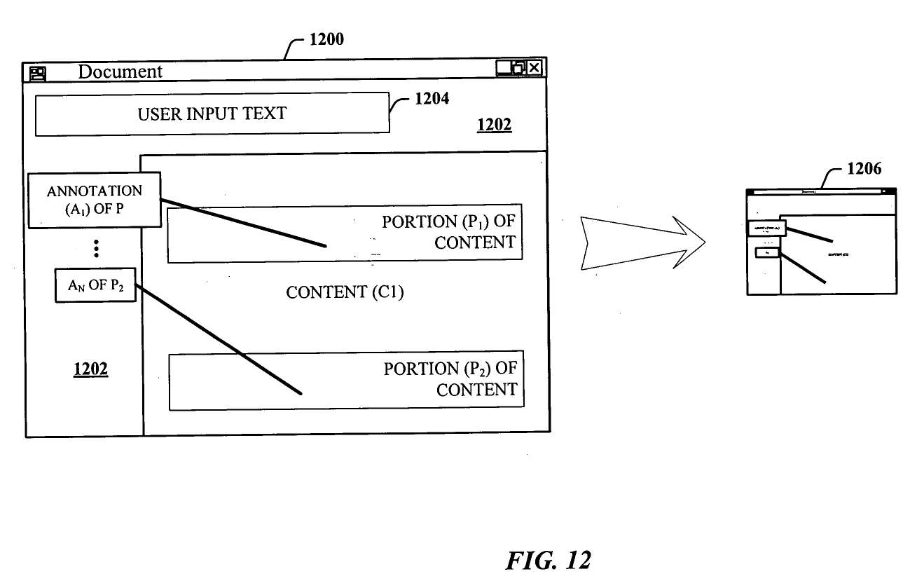

FIG. 12 illustrates reduction of an annotated web document 1200 associated with user activity. As indicated supra, an annotation area 1202 is created in association with the web document 1200 for user annotation. For example, a single annotation (denoted ANNOTATION A₁), or multiple annotations (denoted A₁ to A_{N}, where N is a positive integer) can be created in the area 1202. The user can simply select a portion P₁ of the document content for annotation. Alternatively, or in combination therewith, the user can enter text 1204 into the area 1202. Once completed, the conversion component converts the document 1200 and annotations into a thumbnail image 1206 for visual summarization.

Note that while certain ways of displaying information to users are shown and described with respect to certain figures as screenshots, those skilled in the relevant art will recognize that various other alternatives can be employed. The terms “screen,” “screenshot”, “webpage,” “document”, “web document” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

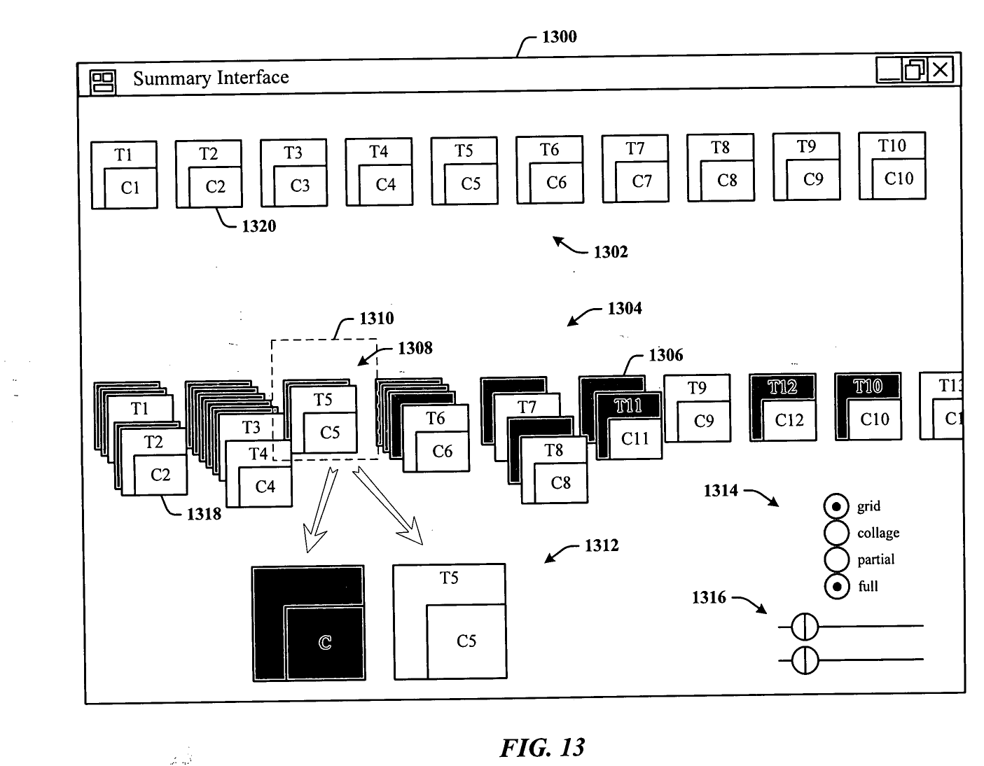

FIG. 13 illustrates a more extensive diagram of a summary interface 1300 for visual summarization in accordance with the subject architecture. In this particular implementation, higher priority data (or data deemed more relevant) 1302 is arranged along the top of the interface 1300. Moreover, the more relevant images 1302 can be arranged in chronological order (e.g., from left-to-right) to provide a historical sense of the activity. An all-inclusive set 1304 of activity images is presented for visual review below the set of relevant images 1302. The all-inclusive set 1304 can include both the relevant set 1302 and less relevant images (grayed blocks) 1306 in a mixed arrangement. Multiple associated images of the all-inclusive set 1304 are stacked in an offset layered manner to conserve on viewing space, yet indicate to the viewer that additional activity data is available for perusing, if so desired. The user can review a stack, for example a stack 1308, by selecting (e.g., using a selection method of bounding the stack in a selection box 1310) the stack 1308, which causes the stack images to be enlarged and displayed for individual review, as indicated at 1312.

The interface 1300 can also include user controls for manipulating visual presentation of the activity data and associated graphical representations. For example, a set of user controls 1314 facilitate selecting via radio buttons a grid layout, a collage layout, a partial layout, and a full layout.

Currently illustrated, the user has selected a full-grid layout where the visual summary presents all of the images aligned to a transparent grid. The interface 1300 presents additional images partially or not shown at all, but which can be viewed by grabbing a part of the interface and scrolling to the desired images. The controls 1314 also include slider controls 1316, one of which is configured (or programmed) to allow the fading out of less relevant images (e.g., image 1306) before the more relevant images (e.g., image 1318) of the all-inclusive set 1304, providing for more convenient viewing of the remaining images.

In another implementation, an image 1320 of the more relevant set 1302 can be linked to an audio file or a video file such that when the user selects the image, the linked file(s) are presented.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

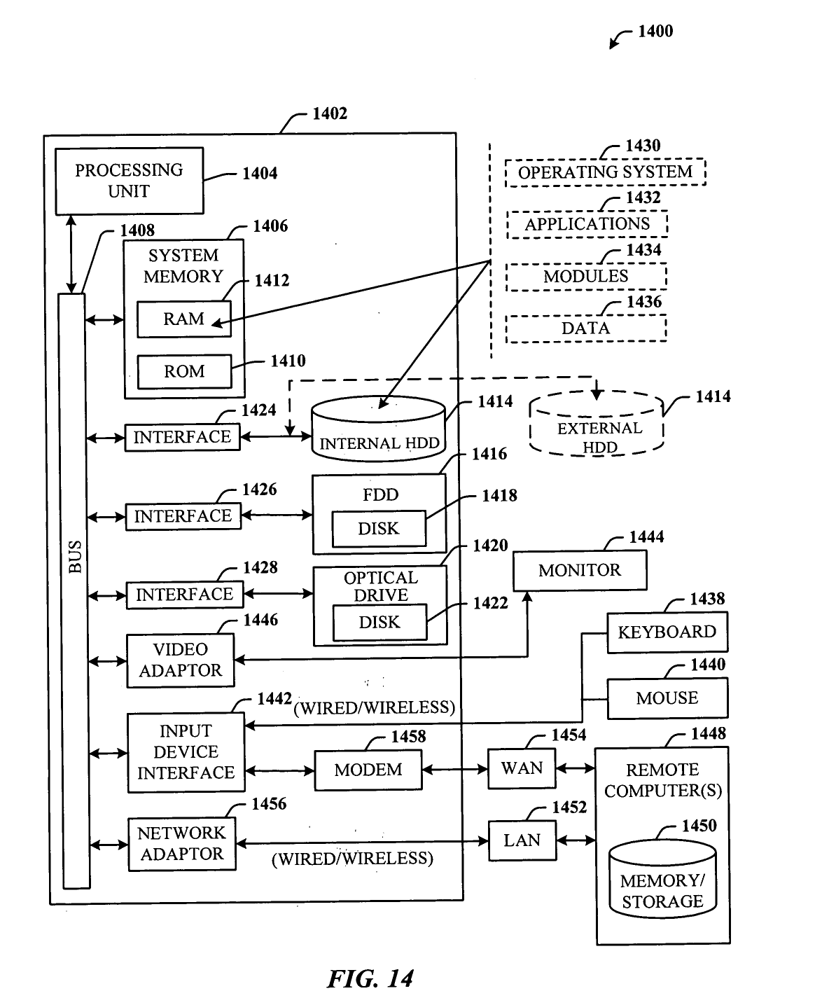

Referring now to FIG. 14, there is illustrated a block diagram of a computer operable to execute the disclosed visual summarization and presentation architecture. In order to provide additional context for various aspects thereof, FIG. 14 and the following discussion are intended to provide a brief, general description of a suitable computing environment 1400 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 14, the exemplary environment 1400 for implementing various aspects includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1412, including an operating system 1430, one or more application programs 1432 (e.g., a browser for accessing web documents, a tracking component for tracking user web activity, and a visualization component for summarizing visually the user web activity), other program modules 1434 and program data 1436. All or portions of the operating system, applications, modules, and/or data can also be cached in the RAM 1412. It is to be appreciated that the innovation can be implemented with various commercially available operating systems or combinations of operating systems.

A user can enter commands and information into the computer 1402 through one or more wired/wireless input devices, for example, a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1394 serial port, a game port, a USB port, an IR interface, etc.

A monitor 1444 or other type of display device is also connected to the system bus 1408 via an interface, such as a video adapter 1446. In addition to the monitor 1444, a computer typically includes other peripheral output devices (not shown), such as speakers, printers, etc.

The computer 1402 may operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, for example, a wide area network (WAN) 1454. Such LAN and WAN networking environments are commonplace in offices and companies, and facilitate enterprise-wide computer networks, such as intranets, all of which may connect to a global communications network, for example, the Internet.

When used in a LAN networking environment, the computer 1402 is connected to the local network 1452 through a wired and/or wireless communication network interface or adapter 1456. The adaptor 1456 may facilitate wired or wireless communication to the LAN 1452, which may also include a wireless access point disposed thereon for communicating with the wireless adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 via the serial port interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

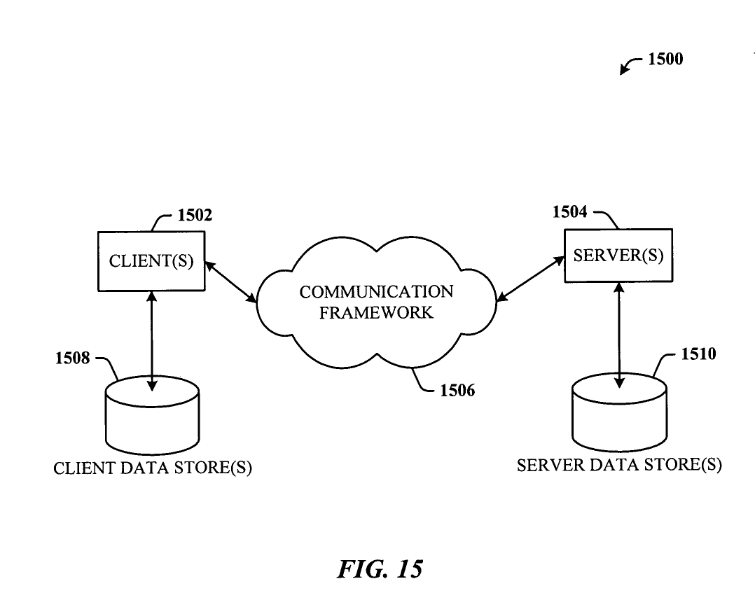

Referring now to FIG. 15, there is illustrated a schematic block diagram of an exemplary computing environment 1500 that facilitates visual summarization and presentation. The system 1500 includes one or more client(s) 1502. The client(s) 1502 can be hardware and/or software (e.g., threads, processes, computing devices). The client(s) 1502 can house cookie(s) and/or associated contextual information by employing the subject innovation, for example.

The system 1500 also includes one or more server(s) 1504. The server(s) 1504 can also be hardware and/or software (e.g., threads, processes, computing devices). The servers 1504 can house threads to perform transformations by employing the architecture, for example. One possible communication between a client 1502 and a server 1504 can be in the form of a data packet adapted to be transmitted between two or more computer processes. The data packet may include a cookie and/or associated contextual information, for example. The system 1500 includes a communication framework 1506 (e.g., a global communication network such as the Internet) that can be employed to facilitate communications between the client(s) 1502 and the server(s) 1504.

Communications can be facilitated via a wired (including optical fiber) and/or wireless technology. The client(s) 1502 are operatively connected to one or more client data store(s) 1508 that can be employed to store information local to the client(s) 1502 (e.g., cookie(s) and/or associated contextual information). Similarly, the server(s) 1504 are operatively connected to one or more server data store(s) 1510 that can be employed to store information local to the servers 1504.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates summarization of user computing activity, comprising:
a tracking component for tracking user activity data of a computing session; and
a visualization component for summarizing the user activity data as a historical visual presentation.

2. The system of claim 1, wherein the tracking component stores user activity data associated with the session for sharing with and visualization by another user.

3. The system of claim 1, wherein the tracking component tracks the user activity data that relates to user interaction with a web page.

4. The system of claim 1, wherein the tracking component tracks the user activity data that relates to user interaction with a local application and local data.

5. The system of claim 1, further comprising a conversion component for converting the user activity data to a thumbnail graphic for presentation by the visualization component.

6. The system of claim 1, wherein the visualization component facilitates annotation of the user activity data with annotation data and conversion of the annotation data and the user activity data into a miniature graphical representation for presentation.

7. The system of claim 1, further comprising an organization component for clustering related data, hiding unrelated data, and emphasizing related data of particular interest.

8. The system of claim 1, wherein the tracking component tracks user activity data related to duration that a user interfaces to at least one of data and an application.

9. The system of claim 1, further comprising a machine learning and reasoning component that employs a probabilistic and/or statistical-based analysis to prognose or infer an action that a user desires to be automatically performed.

10. The system of claim 1, wherein the visualization component facilitates manually navigating through the historical visual representation of the user activity data via manual controls of a user interface.

11. A computer-implemented method of summarizing user computing activity, comprising:
recording activity data associated with an online computing session;
representing the activity data as a set of thumbnail images;
displaying the thumbnail images via a user interface in a historical arrangement; and
managing presentation of the historical arrangement of thumbnail images based on user criteria.

12. The method of claim 11, further comprising controlling the user interface to graphically emphasize images that are deemed more important.

13. The method of claim 11, further comprising controlling the user interface to graphically de-emphasize images that are deemed less important.

14. The method of claim 11, further comprising displaying a priority set of the images separately from the historical arrangement of images.

15. The method of claim 11, further comprising annotating content associated with a document of the activity data.

16. The method of claim 11, further comprising clustering the images based on temporal information associated with the activity data.

17. The method of claim 11, further comprising expanding one of the images to view an associated web document accessed during the session.

18. The method of claim 11, further comprising dynamically changing visual presentation of the historical arrangement of images by manually interacting with the user interface to effect graphical emphasis of a subset of the images.

19. The method of claim 11, further comprising processing the activity data with a decision-theoretic algorithm that learns and reasons about characteristics of the session to cluster and present the images according to a desired arrangement.

20. A computer-executable system, comprising:
computer-implemented means for recording user activity data associated with a network-based computing session;
computer-implemented means for representing the user activity data as a set of thumbnail images that illustrate a history of the user activity data computing session;
computer-implemented means for displaying the history of thumbnail images via a user interface; and
computer-implemented means for filtering the history of thumbnail images by graphically emphasizing one subset of the images more than another subset of images.
